(19) United States
(12) Patent Application Publication
(10) Pub. No.: US 2025/0273186 A1
(43) Pub. Date: Aug. 28, 2025

(54) MULTI-USE APPARATUS FOR AUDIO EQUIPMENT

(71) Applicants: John Brian Pernal, Crossville, TN (US); Rami Daniel Kravetskiy, Crossville, TN (US)

(72) Inventors: John Brian Pernal, Crossville, TN (US); Rami Daniel Kravetskiy, Crossville, TN (US)

(21) Appl. No.: 19/064,509

(22) Filed: Feb. 26, 2025

Related U.S. Application Data
(60) Provisional application No. 63/558,018, filed on Feb. 26, 2024.

(51) Int. Cl. G10D 3/00

(52) U.S. Cl. CPC G10D 3/00

(57) ABSTRACT

A multi-use apparatus includes a rectangular block fabricated from a foam having a closed-cell structure. The rectangular block includes a first face, a second face opposing the first face, and four side faces extending between the first face and the second face. At least two of the side faces have dimensions varying in height, width, or length. The rectangular block is configured to support a lower end of a sound projection device at an angle relative to a surface, the rectangular block providing acoustic isolation and/or vibration dampening between the sound projection device and the surface. Positioning the rectangular block between a proximal and a distal edge of the lower end of the sound projection device selectively adjusts the angle of the sound projection device relative to the surface, thereby modifying a direction of sound projection.

### CROSS REFERENCE TO RELATED APPLICATIONS

The present application claims the benefit of and priority to U.S. Provisional Patent Application No. 63/558,018, filed on Feb. 26, 2024, the entire contents of which are hereby incorporated by reference in their entirety.

### TECHNICAL FIELD

The present disclosure relates to a multi-use apparatus, and, more specifically, to a multi-use apparatus configured for use with audio equipment.

### BACKGROUND

In the music industry, there is a frequent need for audio equipment that can provide support and/or acoustic isolation for sound projection devices while also accommodating the storage, transportation, and/or maintenance of equipment such as musical instruments. Conventional solutions often require separate stands or wedges for tilting sound projection devices and separate neck supports or padding for instruments. These disparate products can be cumbersome, unable to adequately dampen vibrations, and fail to provide sufficient protection during transport or maintenance. For example, wedge-type devices can tilt a speaker cabinet but offer minimal or no vibration dampening. Moreover, such devices are limited to a single tilt angle, and are otherwise too bulky for convenient transport. Metal-framed stands may provide limited adjustability, but can transfer low-frequency vibrations directly through the frame to the floor or stage. Other accessories, such as foam neck supports, are designed strictly to cradle and protect a musical instrument's headstock and neck during string changes or repairs and thus fail to address speaker tilt or acoustic isolation at all. As a result, musicians frequently purchase and carry multiple items, leading to added expense, clutter, and logistical challenges.

Accordingly, there is a need for a multi-use apparatus that addresses these challenges by offering an easy-to-use, durable, and/or adaptable apparatus for use with audio equipment.

### SUMMARY

In accordance with an aspect of the present disclosure, a multi-use apparatus includes a rectangular block fabricated from a foam having a closed-cell structure. The rectangular block includes a first face, a second face opposing the first face, and four side faces extending between the first face and the second face. At least two of the side faces have dimensions varying in height, width, or length. The rectangular block is configured to support a lower end of a sound projection device at an angle relative to a surface, the rectangular block providing acoustic isolation and/or vibration dampening between the sound projection device and the surface. Positioning the rectangular block between a proximal and a distal edge of the lower end of the sound projection device selectively adjusts the angle of the sound projection device relative to the surface, thereby modifying a direction of sound projection.

In an aspect of the present disclosure, the rectangular block may be further configured to support a neck of a musical instrument above the surface during maintenance of the musical instrument.

In another aspect of the present disclosure, the rectangular block may be further configured to secure a position of a musical instrument within a case during storage and/or transportation of the musical instrument.

In yet another aspect of the present disclosure, the rectangular block may be further configured to provide a space between a plurality of musical instruments stored on a stand or a rack.

In a further aspect of the present disclosure, the rectangular block may be fabricated from cross-linked polyethylene (XLPE), chemically cross-linked polyethylene (XPE), and/or ethylene vinyl acetate (EPA).

In yet a further aspect of the present disclosure, the rectangular block may have a length ranging from approximately 2 inches to 6 inches, a width ranging from approximately 1.5 inches to 4 inches, and a height ranging from approximately 1 inch to 3 inches.

In another aspect of the present disclosure, the rectangular block may have a first orientation configured to tilt the sound projection device at a first angle relative to the surface, and a second orientation configured to tilt the sound projection device at a second angle relative to the surface. The second orientation may be obtained by rotating the rectangular block about an axis relative to the surface.

In yet another aspect of the present disclosure, the first angle may range from approximately 15 degrees to 31 degrees, and the second angle may range from approximately 25 degrees to 33 degrees.

In a further aspect of the present disclosure, the rectangular block may further include at least one arcuate recess defined in a first side face thereof. The arcuate recess may be configured to accommodate a neck of a musical instrument.

In yet a further aspect of the present disclosure, the rectangular block may further include an external layer configured to enhance a grip between the rectangular block and the surface.

In an aspect of the present disclosure, a method for using a multi-use apparatus includes: providing a rectangular block fabricated from a foam having a closed-cell structure, the rectangular block including a first face, a second face opposing the first face, and four side faces extending between the first face and the second face; supporting, by the rectangular block, a lower end of a sound projection device at an angle relative to a surface, the rectangular block providing acoustic isolation and/or vibration dampening between the sound projection device and the surface; and positioning the rectangular block between a proximal and a distal edge of the lower end of the sound projection device to selectively adjusts the angle of the sound projection device relative to the surface, thereby modifying a direction of sound projection. At least two of the side faces have dimensions varying in height, width, or length.

In another aspect of the present disclosure, the method may further include supporting, by the rectangular block, a neck of a musical instrument above the surface during maintenance of the musical instrument.

In yet another aspect of the present disclosure, the method may further include securing, by the rectangular block, a position of a musical instrument with a container during storage and/or transportation of the musical instrument.

In a further aspect of the present disclosure, the method may further include providing, by the rectangular block, a space between a plurality of musical instruments stored on a stand and/or rack.

In yet a further aspect of the present disclosure, the method may further include fabricating the rectangular block from cross-linked polyethylene (XLPE), chemically cross-linked polyethylene (XPE), and/or ethylene vinyl acetate (EPA).

In another aspect of the present disclosure, the rectangular block may have a length ranging from approximately 2 inches to 6 inches, a width ranging from approximately 1.5 inches to 4 inches, and a height ranging from approximately 1 inch to 3 inches.

In yet another aspect of the present disclosure, the method may further include rotating the rectangular block about an axis relative to the surface to adjust a height of the rectangular block. The rectangular block may have a first orientation configured to tilt the sound projection device at a first angle relative to the surface, and a second orientation configured to tilt the sound projection device at a second angle relative to the surface.

In a further aspect of the present disclosure, the first angle may range from approximately 15 degrees to 31 degrees, and the second angle may range from approximately 25 degrees to 33 degrees.

In yet a further aspect of the present disclosure, the rectangular block may further include at least one arcuate recess defined in a first side face thereof. The arcuate recess may be configured to accommodate a neck of a musical instrument.

In accordance with an aspect of the present disclosure, a multi-use apparatus includes an asymmetrical block fabricated from a foam having a closed-cell structure. The asymmetrical block includes a first face, a second face opposing the first face, and four side faces extending between the first face and the second face. At least two of the side faces have dimensions varying in height, width, or length. The asymmetrical block is configured to support a lower end of a sound projection device at an angle relative to a surface, the asymmetrical block providing acoustic isolation and/or vibration dampening between the sound projection device and the surface. Positioning the asymmetrical block between a proximal and a distal edge of the lower end of the sound projection device selectively adjusts the angle of the sound projection device relative to the surface, thereby modifying a direction of sound projection.

Further details and aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying figures of which:

FIG. 1 is a perspective view of a multi-use apparatus, in accordance with aspects of the present disclosure;

FIGS. 2A-2F are perspective views illustrating various configurations of a sound projection device and the multi-use apparatus of FIG. 1, in accordance with aspects of the present disclosure;

FIGS. 3A and 3B are perspective views illustrating configurations of a musical instrument and the multi-use apparatus of FIG. 1, in accordance with aspects of the present disclosure;

FIG. 4 is a perspective view illustrating a configuration of a stand, multiple musical instruments, and the multi-use apparatus of FIG. 1, in accordance with aspects of the present disclosure;

FIGS. 5A and 5B are perspective views illustrating configurations of a case, a musical instrument, and the multi-use apparatus of FIG. 1, in accordance with aspects of the present disclosure; and

FIG. 6 a perspective view of another multi-use apparatus, in accordance with aspects of the present disclosure; and;

FIG. 7 is a block diagram of a method of using the multi-use apparatus of FIG. 1, in accordance with aspects of the present disclosure.

### DETAILED DESCRIPTION

The present disclosure relates to a multi-use apparatus, and, more specifically, to a multi-use apparatus configured for use with audio equipment, which integrates angled support, vibration dampening, acoustic isolation, security, and/or storage functions into a single, versatile multi-use apparatus.

Aspects of the present disclosure are described in detail with reference to the figures wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the figures, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

As used herein, “audio equipment” may include any equipment and/or device any equipment used in the music industry, including devices for producing, amplifying, projecting, and/or manipulating sound, such as speaker cabinets, audio amplifiers, PA systems, studio monitors, sound reinforcement systems, and/or other electronic or acoustic sound-emitting devices. In addition, audio equipment may include various speaker configurations, such as guitar amplifier cabinets, bass amplifier cabinets, combo amplifiers, 4×12 and 2×12 speaker cabinets, and/or other enclosures housing one or more speakers for sound projection. Further, audio equipment may extend to devices used in live performances, recording studios, rehearsal spaces, and/or general sound reinforcement applications, ensuring broad applicability across musical, commercial, and professional audio settings.

The multi-use apparatus described herein addresses a range of common challenges faced by musicians, audio engineers, sound technicians, and other users, enabling more efficient transport, setup, and handling of audio equipment. Using state-of-the art compositions, the lightweight construction avoids unnecessary bulk while still maintaining sufficient durability and functionality for professional use. In addition, the dimensions allow for an optimized tilt angle for sound projection devices and more ergonomic and/or secure positing during maintenance. Unlike bulkier repair stands or dedicated neck cradles, the multi-use apparatus is compact and lightweight, allowing musicians and technicians to easily transport it in a gig bag, case, or tool kit. This portability makes the multi-use apparatus particularly useful for on-the-go maintenance, whether in a touring environment, recording studio, rehearsal space, or backstage setting. While this disclosure focuses on a multi-use apparatus for use with a sound projection device and musical instruments, the multi-use apparatus may be adapted for a broad range of additional applications and/or devices. In particular, the adaptable configuration and supportive properties of the multi-use apparatus enable application for any scenario requiring stable positioning, adjustable angling, acoustic isolation, vibration dampening, and/or secure storage.

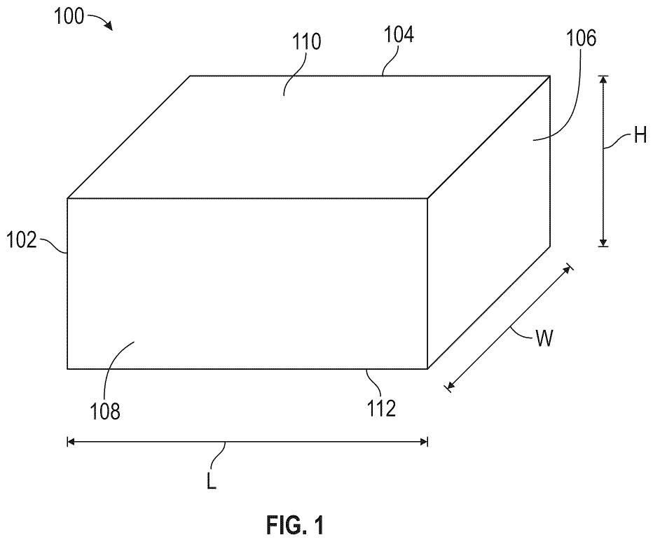

Referring to FIG. 1, a multi-use apparatus 100 is shown according to aspects of the present disclosure. Multi-use apparatus 100 generally includes side faces 102, 104, 106, 108, first face 110, and second face 112, e.g., a six-sided block-like structure (e.g., a rectangular block). The first face 110 (e.g., an upper face) and the second face 112 (e.g., a lower face) are opposing faces that define the uppermost and lowermost surfaces, respectively, of the multi-use apparatus 100. The side faces 102, 104, 106, 108 extend between the first face 110 and the second face 112, defining the lateral boundary of the multi-use apparatus 100, e.g., forming the side surfaces of the multi-use apparatus 100 and/or enclosing the block-like structure. Opposing pairs of side faces may include side faces 102, 106 and side faces 104, 108, which are positioned opposite each other.

Side faces 102, 104, 106, 108 may extend along a vertical axis (e.g., axis H), while the first face 110 and the second face 112 may extend along a horizontal axis (e.g., axis W), which is perpendicular to the vertical axis (H). While generally described as a six-sided block, the multi-use apparatus 100 may be configured with any number of suitable shapes, faces, and/or dimensions to accommodate different applications of the multi-use apparatus 100 (e.g., sound projection device, spacer, and/or musical instrument support system). In aspects, the multi-use apparatus 100 may be fabricated as a block, a cube, a rectangle, or a combination thereof with adjustable configurations.

In aspects, at least one face of multi-use apparatus 100 may be inclined at a non-perpendicular angle, such that at least one side face 102, 104, 106, 108 defines an acute and/or obtuse angle relative to an adjacent side face, creating a non-uniform profile of the multi-use apparatus 100. For example, at least one side face 102, 104, 106, 108 may be inclined at a 45° angle relative to an axis (e.g., axis L or axis W) defined by the first face 110 and the second face 112, forming an irregular and/or asymmetrical shape while maintaining the overall six-sided structure. This wedge-like shape of a six-sided structure may provide an optimized tilt angle for sound projection devices, (e.g., improving sound projection and acoustic isolation), enable more ergonomic and/or secure positing (e.g., when used as a support surface for a musical instrument), and/or enable additional height and tilt configurations for adaptability in various storage and/or spacing applications.

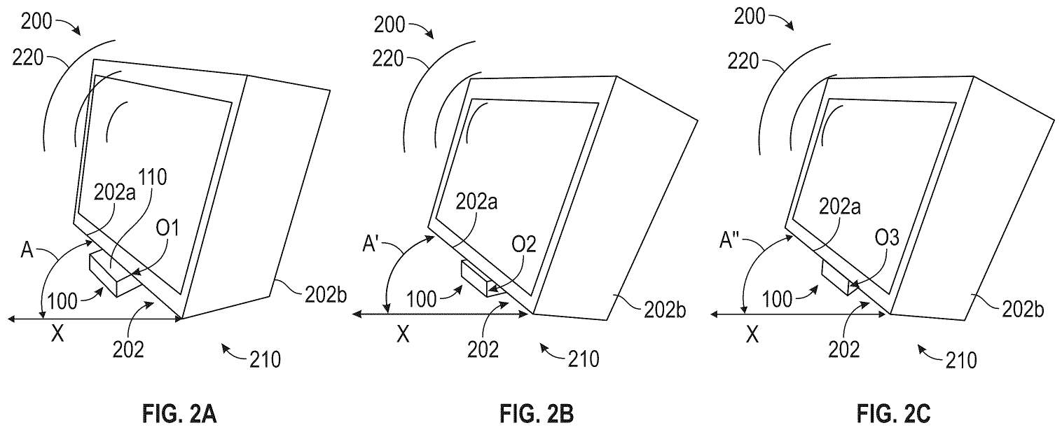

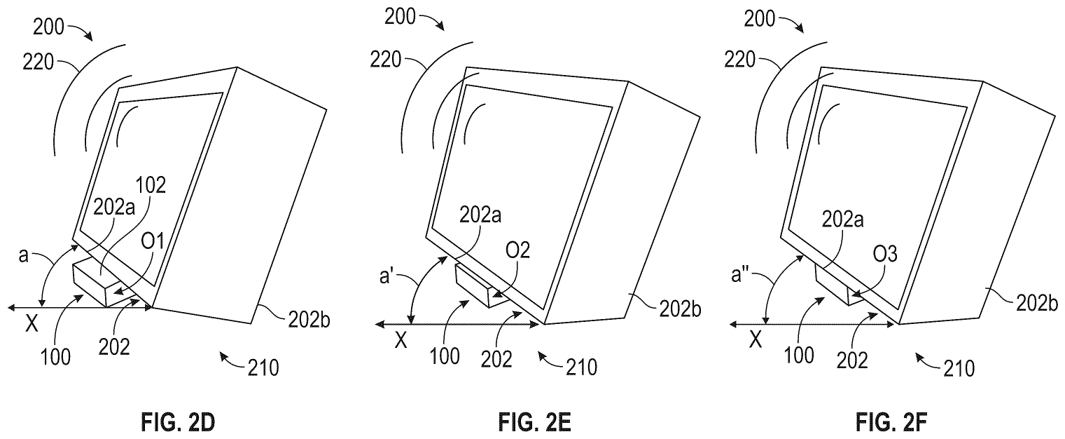

The multi-use apparatus 100 is generally configured as a block with dimensions of approximately 4 inches in length, 3 inches in width, and 2 inches in height (e.g., 4″L×3″W×2″D block). Generally, the dimensions of the multi-use apparatus 100 range between approximately 3-6 inches in length, 1.5-4 inches in width, and 1-3 inches in height. Such compact dimensions optimize the functionality of the multi-use apparatus 100 for various applications, thereby facilitating the ease of setup, transportation, and/or storage thereof. For example, the dimensions ensure compatibility with a wide range of sound projection devices (FIGS. 2A-2F), providing stable and/or adjustable tilt angles while maintaining effective acoustic isolation. Additionally, the dimensions allows the apparatus to function as a support for musical instruments and as a spacer within instrument cases or storage setups.

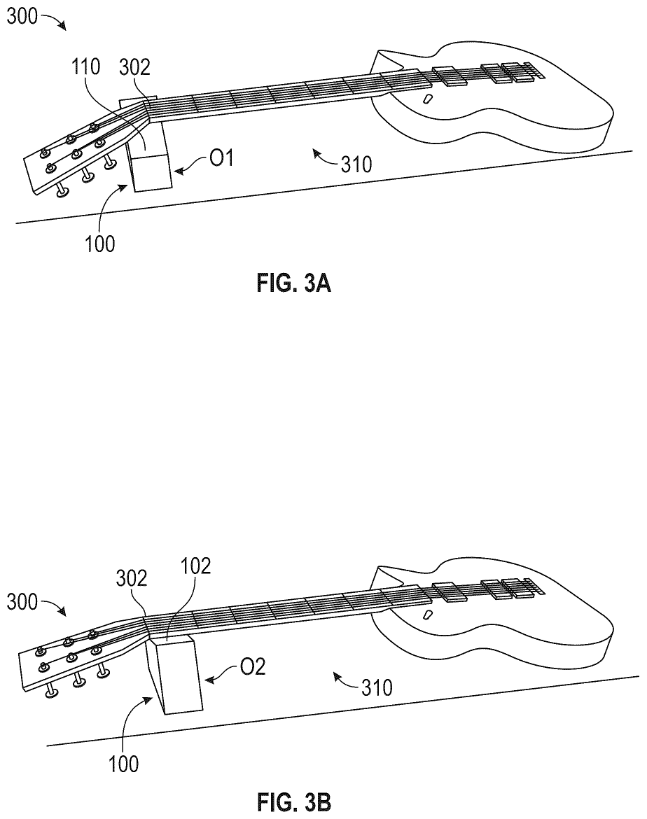

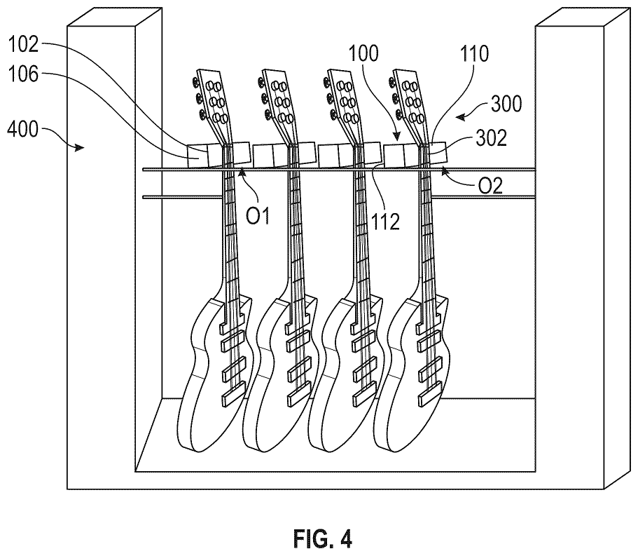

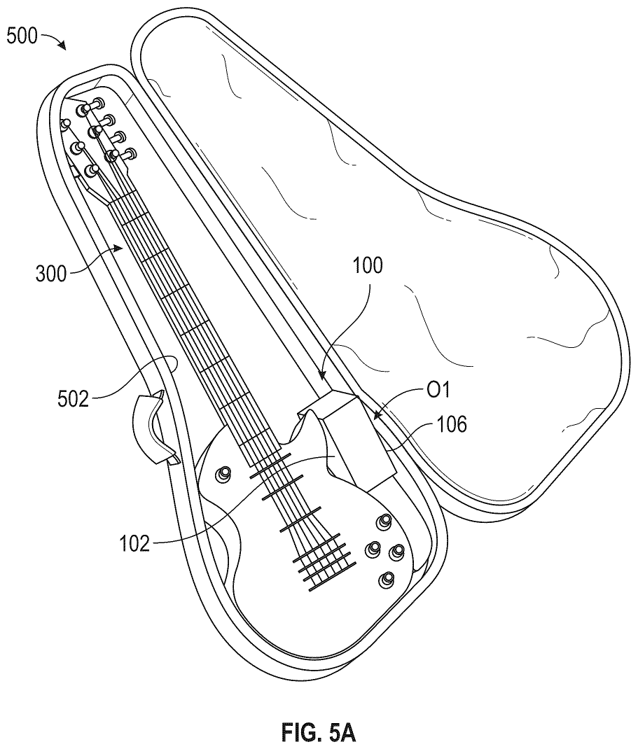

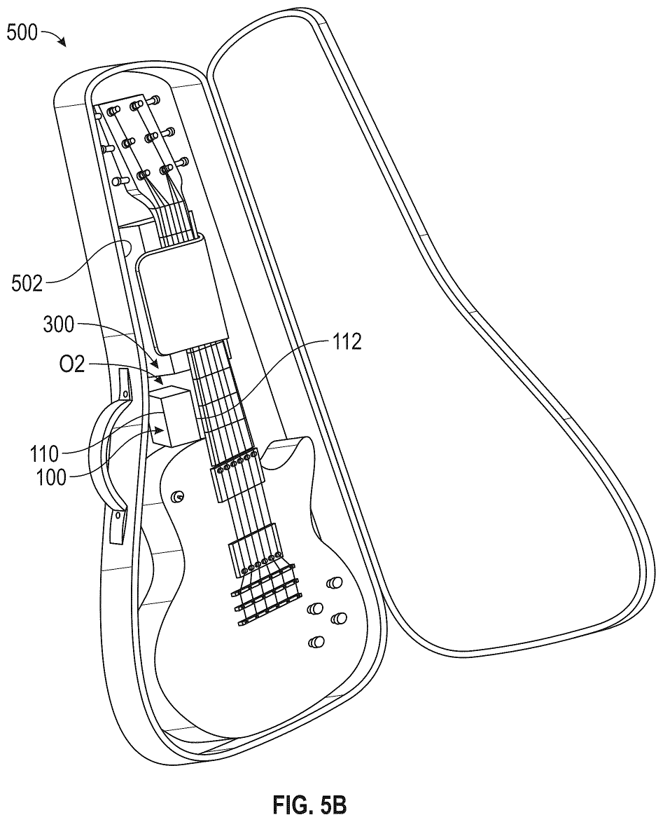

Generally, at least two of the side faces 102, 104, 106, 108 vary in dimension, e.g. vary in at least one of length, width, or height. This difference in dimensions allows the multi-use apparatus 100 to be positioned in multiple orientations, enabling various functional advantages such as tilting variations (FIGS. 2A-2F), instrument support adaptability (FIGS. 3A, 3B), and/or storage or spacer functionality (FIGS. 4, 5A, 5B). For example, the first face 110 and the second face 112 of the multi-use apparatus 100 may be configured with the same dimensions. For example, the first face 110 and the second face 112 may each measure approximately 4 inches in length and 3 inches in width, corresponding to the overall length and width of the multi-use apparatus 100. In aspects, at least two of the side faces 102, 104, 106, 108 are configured to vary in dimension. For example, side faces 102, 106 may each measure approximately 3 inches in width and 2 inches in height, corresponding to the overall height and width of the multi-use support apparatus. In another example, side faces 104, 108 may each measure approximately 4 inches in length and 2 inches in height, corresponding to the overall height and length of the multi-use apparatus 100.

The multi-use apparatus 100 is generally fabricated from cross-linked polyethylene (XLPE) foam, which provides an optimal balance of durability and/or noise reduction while maintaining a lightweight structure for ease of transport and repositioning. XLPE provides various advantages over traditional foam applications, particularly superior sound absorption and/or acoustic isolation properties. The dense, closed-cell structure of the XLPE foam is also configured to provide heightened shock absorption and enhance a resistance of the multi-use apparatus 100 to compression, moisture, chemicals, temperature, and/or fire, enabling ease of repeated use in supporting sound projection devices, musical instruments, and/or other equipment. In addition, XLPE is eco-friendly as it requires less energy to produce and is highly durable, thereby reducing waste over time.

In aspects, the multi-use apparatus 100 may incorporate materials such as chemically cross-linked polyethylene (XPE), ethylene vinyl acetate (EVA) foam, polyvinyl chloride foam (PVC) foam, expanded polyethylene (EPE) foam, ethylene propylene diene monomer (EPDM) foam, open cell, filter foam, natural rubber, polyisocyanurate foam, and/or rigid polymers, based on a desired level of firmness, flexibility, and/or impact resistance for a particular application. For example, EVA foam is another closed-cell structure, which has a generally lighter weight and provides advantages including low water absorption, ultraviolet radiation (UV) resistance, high durability, enhanced flexibility and cushioning, and/or stress-crack resistance. For example, a layer of EVA foam may be incorporated in the multi-use apparatus 100 to enhance a flexibility for ease of molding into different shapes and sizes while maintaining structural integrity (e.g., to conform to a contour within an instrument case). EVA foam may also enhance a cushioning property of the multi-use apparatus 100 where impact absorption is critical (e.g., shock absorption within an instrument case). For example, a layer of rubber composites and/or other polymers may provide enhanced grip and/or impact resistance.

In aspects, a combination of foam and/or polymers may be incorporated into multi-use apparatus 100 to achieve specific acoustic damping properties, thereby ensuring effective minimization of vibrations and/or unwanted resonance when the multi-use apparatus 100 is used as a support or spacer. For example, a layered and/or composite configuration (e.g., a dual-layered structure) combining XLPE for structural integrity with EVA for additional cushioning may optimize acoustic isolation. In another example, an external PVC-coated layer and/or textured surface may be applied to improve durability and surface grip, reducing movement on a smooth or hard surface 210. These combinations allow the multi-use apparatus 100 to effectively function across multiple applications, including supporting cabinets, stabilizing musical instruments during maintenance, and/or securing instruments within cases during transport.

Now referring to FIGS. 2A-2F various configurations of a sound projection device 200 and the multi-use apparatus 100 are shown, according to aspects of the present disclosure. In aspects, sound projection device 200 is a 1×12″ speaker. As used herein, a sound projection device 200 may include a speaker amplifier cabinet, a guitar amplifier, a combination amplifier, a 4×12 speaker cabinet, a 2×12 speaker cabinet, a bass amplifier cabinet, a keyboard amplifier, and/or any other enclosure housing one or more speakers for sound amplification.

The multi-use apparatus 100 is configured to support a lower end 202 of the sound projection device 200. In doing so, the multi-use apparatus 100 serves a dual function by enabling adjustable tilt positioning and acoustic isolation and/or vibration dampening for the sound projection device 200. For example, the multi-use apparatus 100 is configured to enable adjustable tilt positioning of the sound projection device 200 at an angle relative to a surface 210 (e.g., a stage, platform, riser, and/or other surface) along an axis X. The angle may be adjusted in a desired direction to influence a sound projection 220, e.g., a projection of sound waves toward a musician and/or an audience. In addition, the multi-use apparatus 100 is configured to enhance acoustic and/or harmonic isolation properties of the sound projection device 200 by reducing vibration transfer between the sound projection device 200 and the surface 210. The multi-use apparatus 100 provides an advantage over traditional tilt and/or support devices by enabling a greater range of tilt and lesser degrees in such tilt, while preventing the sound projection device 200 from falling, e.g., preventing an amplifier cabinet from falling to a base.

The multi-use apparatus 100 is generally placed below a central point of the lower end 202 of the sound projection device 200 for optimal sound absorption and/or acoustic isolation. However, the multi-use apparatus 100 may be placed in any number of depth configurations, such as anywhere along the lower end 202 of the sound projection device 200 between a proximal edge 202a and a distal edge 202b. In addition, the multi-use apparatus 100 can be configured in various orientations based on which face of the multi-use apparatus 100 is supporting the lower end 202 of the sound projection device 200. By rotating the multi-use apparatus 100 about an axis (e.g., X) relative to the surface 210, an alternative orientation of apparatus 100 may be achieved. The depth configuration and/or the orientation of multi-use apparatus 100 may determine the tilt positioning of the sound projection device 200, defining an adjustable angle of the sound projection device 200 along the axis X relative to the surface 210. For example, a configuration closer to proximal edge 202a of sound projection device 200 and/or a shorter orientation of multi-use apparatus 100 may result in a lower angle, whereas a configuration closer to distal edge 202b of sound projection device 200 and/or a taller orientation of multi-use apparatus 100 may result in a higher angle.

With further reference to FIGS. 2A-2C, configurations of the sound projection device 200 and the multi-use apparatus 100 in the first orientation O1 (e.g., a “standard” placement) are shown. In the first orientation O1, the first face 110 of the multi-use apparatus 100 may be supporting the lower end 202 of the sound projection device 200, defining a 4″×3″×2″ rectangular block. As the depth configuration of the multi-use apparatus 100 moves closer to the distal edge 202b of the sound projection device 200, the angle of the sound projection device 200 may increase, ranging between approximately 15°-31° vertical tilt (e.g., with a multi-use apparatus 100 based on a 4″×3″×2″ 4-pound XLPE foam block and a sound projection device 200 against a flat surface 210). For example, FIG. 2A illustrates the multi-use apparatus 100 in a first configuration, e.g., extending approximately 1″ outward and/or proximally from the proximal edge 202a to define a first angle A (e.g., 15°). FIG. 2B illustrates the multi-use apparatus 100 in a second configuration, e.g., flush against proximal edge 202a, to define a second angle A′ (e.g., 20°). FIG. 2C illustrates the multi-use apparatus 100 in a third configuration, e.g., extending approximately 1″ inward and/or distally from the inner edge 202a to define a third angle A″ (e.g., 31°).

With further reference to FIGS. 2D-2F, configurations of the sound projection device 200 and the multi-use apparatus 100 in a second orientation O2 (e.g., a “tall side orientation”) are shown. In the second orientation O2, a side face 102 of the multi-use apparatus 100 may be supporting the lower end 202 of the sound projection device 200, defining a 3″×2″4″ rectangular block. As the depth configuration of the multi-use apparatus 100 moves closer to the distal edge 202b of the sound projection device 200, the angle of the sound projection device 200 may increase, ranging between approximately 25°-33° vertical tilt. For example, FIG. 2D illustrates the multi-use apparatus 100 in a fourth configuration, e.g., extending approximately 1″ outward and/or proximally from the proximal edge 202a to define a first angle a (e.g., 25°). FIG. 2E illustrates the multi-use apparatus 100 in a fifth configuration, e.g., flush against the proximal edge 202a, to define a second angle A′ (e.g., 27°). FIG. 2F illustrates the multi-use apparatus 100 in a sixth configuration, e.g., extending approximately 1″ inward and/or distally from the proximal edge 202a to define a third angle A″ (e.g., 33°).

In aspects, in a third orientation O3, a side face 108 of the multi-use apparatus 100 may be supporting the lower end 202 of the sound projection device 200, defining a 4″×2″3″ rectangular block (e.g., a “third height”). This and other orientations and/or configurations are contemplated and understood by one of ordinary skill in the art. For example, various side-to-side configurations of the multi-use apparatus 100 while supporting the lower end 202 of the sound projection device 200 are contemplated.

Now referring to FIGS. 3A and 3B, configurations of a musical instrument 300 and the multi-use apparatus 100 are shown, according to aspects of the present disclosure. In aspects, the musical instrument 300 is a string instrument. As used herein, a musical instrument 300 may include any device and/or apparatus designed to produce sound for musical performance, recording, and/or amplification, including string instruments (e.g., guitars, bass guitars, violins, cellos), percussion instruments (e.g., drums, electronic drum pads), wind instruments (e.g., saxophones, trumpets, flutes), keyboard instruments (e.g., pianos, synthesizers, electric keyboards), and/or electronic or digital instruments (e.g., musical instrument digital interface (MIDI) controllers, samplers, and other electronically generated sound devices).

A composition of the multi-use apparatus 100 (e.g., XLPE and/or XPE) offers both structural support and compressibility to cushion the musical instrument 300. The closed-cell structure of the multi-use apparatus 100 provides resilience and durability while offering sufficient support to prevent unwanted movement of a musical instrument 300. This composition ensures that the multi-use apparatus 100 maintains a shape under load while also absorbing minor vibrations and/or impact forces that may transfer to the musical instrument 300. For example, based on a 4″×3″×2″ 4-pound XLPE foam block with an average compressive strength of 25 pounds per square inch (PSI), the multi-use apparatus 100 may support up to 300 pounds of weight. Therefore, the XLPE foam supports an enhanced amount of weight for a relatively small sized device, thereby enabling support for a variety of sizes and shapes of musical instruments 300. In addition, the non-slip properties of XLPE and/or XPE foam further enhance grip and adherence of the multi-use apparatus 100 to the surface 304, thus preventing unintended movement when used on smooth surfaces 304 such as workbenches and/or stage floors.

With further reference to FIGS. 3A and 3B, multi-use apparatus 100 is configured to support a neck 302 of the musical instrument 300 by providing a sturdy yet flexible resting surface, which supports and/or elevates the neck 302 of the musical instrument 300 above a working surface 310. For example, a user may rest the neck 302 of the musical instrument 300 on the first surface 110 of the multi-use apparatus 100 to enable ease of changing strings, adjusting hardware, tuning, cleaning, and/or other maintenance tasks related to the musical instrument 300. Similar to FIGS. 2A-2F, the multi-use apparatus 100 can be positioned in multiple orientations to accommodate musical instruments of diverse sizes. By adjusting the orientation of the multi-use apparatus 100, a height at which the neck 302 of the musical instrument 300 is supported can be selectively adjusted, providing versatility for different maintenance needs and/or musical instruments 300 with varying neck profiles and thicknesses. In addition, a face (e.g., a flat second face 112) of the multi-use apparatus 100 provides a stable foundation, minimizing tipping and/or instability when supporting the musical instrument 300 during maintenance tasks.

For example, FIG. 3A illustrates the multi-use apparatus 100 in a first orientation O1 (e.g., a “standard” placement). In the first orientation O1, the first face 110 of the multi-use apparatus 100 may be supporting the neck 302 of the musical instrument 300, defining a 4″×3″×2″ rectangular block. FIG. 3B illustrates the multi-use apparatus 100 in a second orientation O2 (e.g., a “tall side orientation”). In the second orientation O2, a side face 102 of the multi-use apparatus 100 may be supporting the neck 302 of the musical instrument 300, defining a 3″×2″4″ rectangular block. In aspects, a third orientation may be configured. The adjustable orientation of multi-use apparatus 100 allows for varied configurations, making the multi-use apparatus 100 adaptable for use with various musical instrument 300s.

Now referring to FIG. 4, a configuration of a rack 400, musical instruments 300, and the multi-use apparatus 100 is shown, according to aspects of the present disclosure. The multi-use apparatus 100 is configured to act as a spacer, e.g., being positioned between multiple musical instruments 300 while placed on the rack 400 as to maintain separation and direction contact among the musical instruments 300 during storage. The rack 400 may include a stand, a storage rack, a display system, and/or any other structure configured to hold multiple musical instruments 300.

For example, multiple multi-use apparatuses 100 may be placed firmly between the necks 302 of each musical instrument 300 on the rack 400, thereby minimizing the risk of scratches, dents, or other damage that may occur from accidental impact. The closed-cell foam composition (e.g., XLPE, XPE, and/or EVA) provides a soft and durable cushion to absorb minor vibrations and/or maintaining structural integrity of each multi-use apparatus 100 under pressure. Additionally, the varying side configurations and/or orientations (e.g., O1, O2, O3) of the multi-use apparatus 100 enable adjustable spacing, accommodating varied sizes of musical instruments 300 and provide extra cushioning (e.g., O2 may provide additional protection) to enable a flexible arrangement of musical instruments 300 on the rack 400. This functionality provides an advantage of multi-use apparatus over traditional storage devices, particularly in studio, retail, and/or touring environments where musical instruments 300 are stored closely together and require organized, protective separation to maintain optimal condition.

Now referring to FIGS. 5A and 5B, configurations of a case 500, a musical instrument 300, and the multi-use apparatus 100 are shown. The multi-use apparatus 100 is configured to act as a spacer and/or guard, e.g., being positioned between a musical instruments 300 and a case wall 502 of a case 500 while stored therein to secure the musical instrument 300 in a position and maintain separation and direction contact with the case 500 during transportation and/or storage. The case 500 may include soft cases, fitted cases, and/or hard-shell cases, each of which presents unique challenges in ensuring a proper fit and preventing instrument movement.

FIG. 5A illustrates a musical instrument 300 stored in a case 500 having a soft configuration. In the soft configuration of the case 500, there may be no internal shape and/or specific containment mechanism within the case 500 to secure and/or stabilize the musical instrument 300 therein, thereby providing a loose fit. The multi-use apparatus 100 may be used as a spacer and/or filler to reduce excess space within case 500 and/or prevent unwanted shifting of the musical instrument 300 when inside the case 500. For example, the multi-use apparatus 100 may be placed in the first orientation O1, where side face 102 is disposed on the musical instrument 300 and side face 106 is disposed on the case wall 502.

FIG. 5B illustrates a musical instrument 300 stored in a case 500 having a fitted configuration. In the fitted configuration of the case 500, there may be an internal shape and/or specific containment mechanism designed for a specific musical instrument 300, thereby providing a tight fit. The multi-use apparatus 100 may be used as a spacer and/or filler to reduce excess space within case 500, which may be significantly less than a case 500 having a soft configuration. For example, the multi-use apparatus 100 may be placed in the second orientation O2, where first face 110 is disposed on the musical instrument 300 and second face 112 is disposed on the case wall 502.

In aspects, case 500 may be a hard-shell case, which typically has a generic shape not specific to any musical instrument 300. Therefore, similar to a soft configuration and/or a fitted configuration of case 500, the multi-use apparatus 100 may be used as a spacer and/or filler to reduce excess space within case 500. Moreover, due to the lack of cushion in the hard-shell configuration of case 500, the closed-cell foam composition (e.g., XLPE or EVA) provides additional impact resistance, enhancing protection of the musical instrument 300 from external forces during transportation. Any orientation (O1, O2, O3) of the multi-use apparatus 100 may be used for flexibility in strategic placement inside case 500.

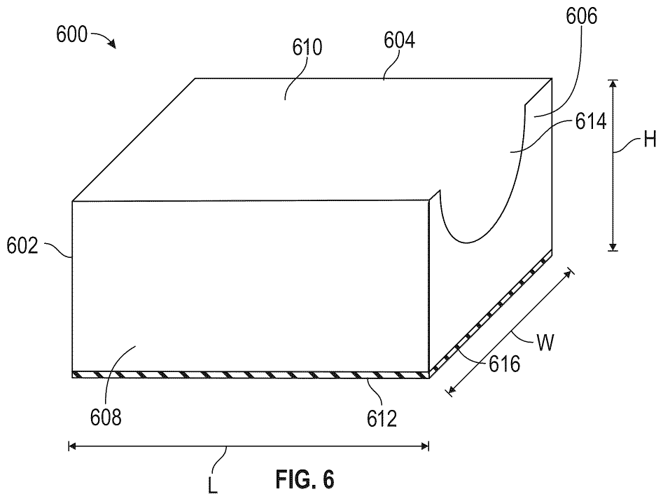

Now referring to FIG. 6, a multi-use apparatus 600 is shown. The multi-use apparatus 600 generally includes side faces 602, 604, 606, 608, a first face 610, and a second face 612, e.g., a six-sided block-like structure (e.g., a rectangular block). The first face 610 (e.g., an upper face) and the second face 612 (e.g., a lower face) are opposing faces that define the uppermost and lowermost surfaces, respectively, of the multi-use apparatus 600. The side faces 602, 604, 606, 608 extend between the first face 610 and the second face 612, defining the lateral boundary of the multi-use apparatus 600, e.g., forming the side surfaces of the multi-use apparatus 600 and/or enclosing the block-like structure. Opposing pairs of side faces may include side faces 602, 606 and side faces 604, 608, which are positioned opposite each other. The multi-use apparatus 600 discloses features similar to the multi-use apparatus 100, with the exception of the features discussed below.

An arcuate recess 614 may be defined in a face of multi-use apparatus 600. The arcuate recess 614 is configured to accommodate the neck 302 of the musical instrument 300, thereby enhancing stabilization and/or securement of the musical instrument 300 during maintenance to prevent unintended movement thereof. For example, the arcuate recess 614 may be defined in a side face 102, 104, 106, 108, thereby confirming to the shape of a neck 302 of a musical instrument. The arcuate recess 614 may be configured with various depths. For example, the arcuate recess 614 may have a shallow curve configured to broaden a contact surface, thereby distributing weight more evenly across the neck 301 and/or body of the musical instrument. In another example, the arcuate recess 614 may have a deeper recess configured to cradle the neck 302 of the musical instrument 300 more securely, minimizing lateral movement during maintenance thereof. In aspects, the arcuate recess 614 may be used as a storage for equipment, for example, for holding strings during maintenance of the musical instrument 300.

While described as an arc-shaped recess, arcuate recess 614 may be in any shape, size, and configuration. For example, the arcuate recess 614 may be an angled and/or stepped recess configured to provide multiple resting points depending on the instrument's neck shape. In aspects, the multi-use apparatus 600 may include multiple arcuate recesses 614 positioned on different faces, allowing for adjustable height and support configurations. In addition, a grip 616 may be disposed on a face of multi-use apparatus 600. The grip 616 is configured to enhance stability, surface adherence, and/or vibration isolation of the multi-use apparatus 600 to prevent unintended movement during use. For example, the grip 616 may be a polymer-based structure affixed to a face of the multi-use apparatus 600. The grip 616 may be glued, heat-bonded, and/or molded onto the apparatus to ensure a durable, long-lasting attachment that withstands repeated use. In another example, the grip 616 may be a textured surface defined in the multi-use apparatus 600 and/or applied as a separate layer to increase traction. The textured surface of the grip 616 may include raised patterns, grooves, ridges, and/or micro-perforations, designed to provide grip in different orientations of use. The placement of grip 616 may vary based on an intended use. For example, when used with sound projection device 200, grip 616 may be placed on second face 212 to enhance friction with the surface 210. In another example, when used as a support for musical instrument 300, grip 616 may be included within the arcuate recess 614 to prevent the neck 302 from shifting therein. In another example, when used as a spacer in a case 500, grip 616 may be included on side faces 602, 606 to enhance friction with case walls 502.

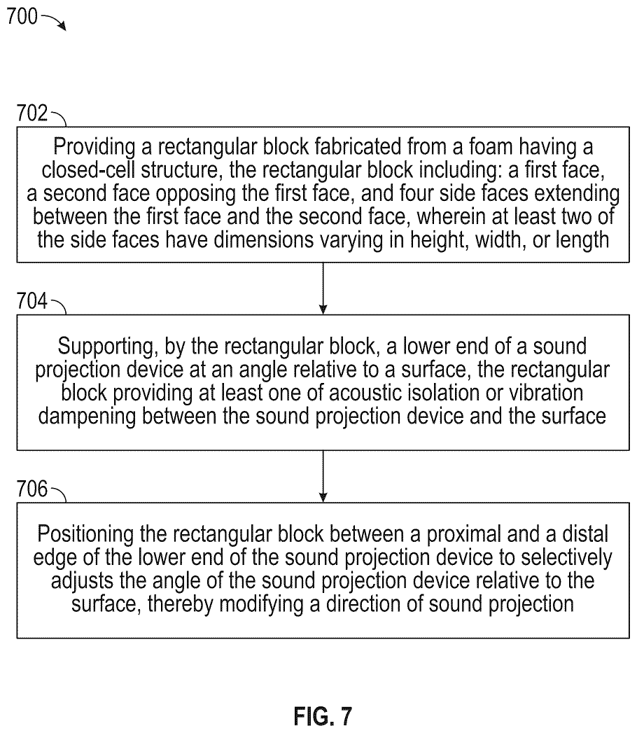

FIG. 7 shows a method 700 for an exemplary use of the multi-use apparatus 100, according to aspects of the present disclosure. Although the steps of method 700 of FIG. 7 are shown in a particular order, the steps need not all be performed in the specified order, and certain steps can be performed in another order. In various aspects, the method 700 of FIG. 7 may be performed all or in part by components of the multi-use apparatus 100. These and other variations are contemplated to be within the scope of the present disclosure.

In step 702, a user provides the multi-use apparatus 100, 600. For example, the user may provide an XLPE rectangular block (4″×3″×2″) fabricated from a foam having a closed-cell structure. The multi-use apparatus may include a first face 110, 610, a second face 112, 612, and side faces 102, 104, 106, 108, 602, 604, 606, 608. The multi-use apparatus 100, 600 may be placed on a surface 210, 310, between necks 302 of musical instruments 300, and/or between a musical instrument 300 and a case 500.

Next, at step 704, the multi-use apparatus 100, 600 supports a lower end 202 of a sound projection device 200 at an angle relative to a surface 210. The multi-use apparatus 100, 600 may provide at least one of acoustic isolation or vibration dampening between the sound projection device 200 and the surface 210. For example, the multi-use apparatus 100, 600 may be placed in a first orientation O1 configured to tilt the sound projection device 200 at a first angle A, e.g., 15° relative to the surface 210.

Next, at step 706, the user may position the multi-use apparatus 100, 600 between a proximal edge 202a and a distal edge 202b of the lower end 202 of the sound projection device 200. For example, the multi-use apparatus 100, 600 may be flush with a proximal edge 202a of the lower end 202 of the sound projection device 200, then pushed one inch distally towards the distal edge 202b of the lower end 202, thereby increasing the angle to a second angle A′, e.g., 20° relative to the surface 210.

The below is data from practical field testing, which provides a comparison of foam blocks having various compositions for acoustic isolation and/or vibration dampening. All subjects were tested at 90 decibels sound performance level (SPL) at 3 feet above a surface with a 4″×3″×2″ block. Low and subharmonic frequencies are generally bellow 250 Hertz and more noticeably below 150 Hertz. The measurement and comparisons started at 220 Hertz, and swept downward to demonstrate the elimination of the most noticeable low frequencies.

### XLPE Foam Block:

| | |
|---|---|
| Feet | Decibels |

Frequencies 220 Hertz and Below (to 20 Hertz)

| | |
|---|---|
| 1 | 3 |
| 3 | 4 |
| 6 | 6 |

Frequencies 110 Hertz and Below (to 20 Hertz)

| | |
|---|---|
| 1 | 4 |
| 3 | 5 |
| 6 | 7 |

Frequencies 75 Hertz and Below (to 20 Hertz)

| | |
|---|---|
| 1 | 5 |
| 3 | 6 |
| 6 | 9 |

### Wooden Block:

| | |
|---|---|
| Feet | Decibels |

Frequencies 220 Hertz and Below (to 20 Hertz)

| | |
|---|---|
| 1 | 0.5 |
| 3 | 1 |
| 6 | 1 |

Frequencies 110 Hertz and Below (to 20 Hertz)

| | |
|---|---|
| 1 | 1 |
| 3 | 1.35 |
| 6 | 1.5 |

Frequencies 75 Hertz and Below (to 20 Hertz)

| | |
|---|---|
| 1 | 1 |
| 3 | 1.75 |
| 6 | 2 |

### Concrete Brick:

| | |
|---|---|
| Feet | Decibels |

Frequencies 220 Hertz and Below (to 20 Hertz)

| | |
|---|---|
| 1 | 0.75 |
| 3 | 1.25 |
| 6 | 1.5 |

Frequencies 110 Hertz and Below (to 20 Hertz)

| | |
|---|---|
| 1 | 0.9 |
| 3 | 1.15 |
| 6 | 1.35 |

Frequencies 75 Hertz and Below (to 20 Hertz)

| | |
|---|---|
| 1 | 1 |
| 3 | 1.15 |
| 6 | 1.3 |

Conclusion: the XPE foam block provides substantially more acoustic isolation and reduces transference of sub-low harmonic frequencies between an amplifier cabinet and surface area (i.e., stage and/or platform) than traditional and/or generic blocks.

Certain aspects of the present disclosure may include some, all, or none of the above advantages and/or one or more other advantages readily apparent to those skilled in the art from the figures, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A multi-use apparatus, comprising:
a rectangular block fabricated from a foam having a closed-cell structure, the rectangular block including:
a first face;
a second face opposing the first face; and
four side faces extending between the first face and the second face, wherein at least two of the side faces have dimensions varying in height, width, or length;
wherein the rectangular block is configured to support a lower end of a sound projection device at an angle relative to a surface, the rectangular block providing at least one of acoustic isolation or vibration dampening between the sound projection device and the surface, and
wherein positioning the rectangular block between a proximal and a distal edge of the lower end of the sound projection device selectively adjusts the angle of the sound projection device relative to the surface, thereby modifying a direction of sound projection.

2. The multi-use apparatus of claim 1, wherein the rectangular block is further configured to support a neck of a musical instrument above the surface during maintenance of the musical instrument.

3. The multi-use apparatus of claim 1, wherein the rectangular block is further configured to secure a position of a musical instrument within a case during at least one of storage or transportation of the musical instrument.

4. The multi-use apparatus of claim 1, wherein the rectangular block is further configured to provide a space between a plurality of musical instruments stored on at least one of a stand or a rack.

5. The multi-use apparatus of claim 1, wherein the rectangular block is fabricated from at least one of cross-linked polyethylene (XLPE), chemically cross-linked polyethylene (XPE), or ethylene vinyl acetate (EPA).

6. The multi-use apparatus of claim 1, wherein the rectangular block has a length ranging from approximately 2 inches to 6 inches, a width ranging from approximately 1.5 inches to 4 inches, and a height ranging from approximately 1 inch to 3 inches.

7. The multi-use apparatus of claim 1, wherein the rectangular block has a first orientation configured to tilt the sound projection device at a first angle relative to the surface, and a second orientation configured to tilt the sound projection device at a second angle relative to the surface, the second orientation obtained by rotating the rectangular block about an axis relative to the surface.

8. The multi-use apparatus of claim 7, wherein the first angle ranges from approximately 15 degrees to 31 degrees, and the second angle ranges from approximately 25 degrees to 33 degrees.

9. The multi-use apparatus of claim 1, wherein the rectangular block further includes at least one arcuate recess defined in a first side face thereof, the arcuate recess configured to accommodate a neck of a musical instrument.

10. The multi-use apparatus of claim 1, wherein the rectangular block further includes an external layer configured to enhance a grip between the rectangular block and the surface.

11. A method for using a multi-use apparatus, comprising:
providing a rectangular block fabricated from a foam having a closed-cell structure, the rectangular block including:
a first face;
a second face opposing the first face; and
four side faces extending between the first face and the second face, wherein at least two of the side faces have dimensions varying in height, width, or length;
supporting, by the rectangular block, a lower end of a sound projection device at an angle relative to a surface, the rectangular block providing at least one of acoustic isolation or vibration dampening between the sound projection device and the surface; and
positioning the rectangular block between a proximal and a distal edge of the lower end of the sound projection device to selectively adjusts the angle of the sound projection device relative to the surface, thereby modifying a direction of sound projection.

12. The method of claim 11, further comprising:
supporting, by the rectangular block, a neck of a musical instrument above the surface during maintenance of the musical instrument.

13. The method of claim 11, further comprising:
securing, by the rectangular block, a position of a musical instrument with a container during at least one of storage or transportation of the musical instrument.

14. The method of claim 11, further comprising:
providing, by the rectangular block, a space between a plurality of musical instruments stored on at least one of a stand or rack.

15. The method of claim 11, further comprising:
fabricating the rectangular block from at least one of cross-linked polyethylene (XLPE), chemically cross-linked polyethylene (XPE), or ethylene vinyl acetate (EPA).

16. The method of claim 11, wherein the rectangular block has a length ranging from approximately 2 inches to 6 inches, a width ranging from approximately 1.5 inches to 4 inches, and a height ranging from approximately 1 inch to 3 inches.

17. The method of claim 11, further comprising:
rotating the rectangular block about an axis relative to the surface to adjust a height of the rectangular block, wherein the rectangular block has a first orientation configured to tilt the sound projection device at a first angle relative to the surface, and a second orientation configured to tilt the sound projection device at a second angle relative to the surface.

18. The method of claim 17, wherein the first angle ranges from approximately 15 degrees to 31 degrees, and the second angle ranges from approximately 25 degrees to 33 degrees.

19. The method of claim 11, wherein the rectangular block further includes at least one arcuate recess defined in a first side face thereof, the arcuate recess configured to accommodate a neck of a musical instrument.

20. A multi-use apparatus, comprising:
an asymmetrical block fabricated from a foam having a closed-cell structure, the asymmetrical block including:
a first face;
a second face opposing the first face; and
four side faces extending between the first face and the second face, wherein at least one of the side faces defines an acute angle relative to an adjacent side face such that the asymmetrical block has a non-uniform profile;
wherein the asymmetrical block is configured to support a lower end of a sound projection device at an angle relative to a surface, the asymmetrical block providing at least one of acoustic isolation or vibration dampening between the sound projection device and the surface, and
wherein positioning the asymmetrical block between a proximal and a distal edge of the lower end of the sound projection device selectively adjusts the angle of the sound projection device relative to the surface, thereby modifying a direction of sound projection.
